(19) United States
(12) Patent Application Publication
(10) Pub. No.: US 2004/0146701 A1
(43) Pub. Date: Jul. 29, 2004

(54) Semiconductor substrate having SOI structure and manufacturing method and semiconductor device thereof

(76) Inventor: Kazuo Taguchi, Chino-shi (JP)

Correspondence Address: HARNESS, DICKEY & PIERCE, P.L.C., P.O. BOX 828, BLOOMFIELD HILLS, MI, 48303, US

(21) Appl. No.: 10/720,846

(22) Filed: Nov. 24, 2003

(30) Foreign Application Priority Data
Nov. 28, 2002 (JP) 2002-345827

(51) Int. Cl. B32B 3/00

(52) U.S. Cl. 428/209

(57) ABSTRACT

A semiconductor substrate, method and device are provided. The substrate is capable of securing a more stable substrate potential and that has a highly reliable SOI structure. A P⁻ type single-crystal silicon layer for forming a device is provided on an insulating layer. In addition, under the insulating layer a P-type support substrate is formed, for example. This support substrate is provided in advance with N-type well patterns. These are deposited as multi-layers so as to comprise a semiconductor substrate having an SOI structure. A predetermined electric potential is applied to each of the well patterns via a connection member that passes through the insulating layer. For example, since a pad is provided in the peripheral region of a chip, regions provided with the well patterns are made to correspond to the pad. Other regions are also provided in accordance with device regions.

### BACKGROUND OF THE INVENTION

1. Field of the Invention

The present invention relates to a semiconductor substrate having a silicon-on-insulator (SOI) structure where the electrical interconnection among devices on a substrate having an SOI structure is improved and to a manufacturing method and a semiconductor device thereof.

2. Related Art

SOI (silicon-on-insulator) technology is known as a technique for forming integrated circuit devices such as MOSFETs in a single-crystal silicon formed on an insulating layer. A CMOS device in an SOI structure has an advantage over a bulk CMOS device in that the source/drain junction capacitance can be reduced. Because of its lower junction capacitance, an SOI CMOS device operates faster than a MOSFET fabricated on a normal bulk silicon substrate (bulk MOSFET). In addition, since SOI CMOS devices operate at high speed even at low voltages, their application in low-power LSIs is being investigated.

There are also many problems with SOI technology. The problem of self-heating caused by the flow of current is one. Another problem is electrostatic discharge (ESD) protection, since an SOI structure lacks vertical diodes, vertical transistors, vertical pnpn paths and other bulk-type devices that are used in normal bulk silicon substrates. Thus, there are problems in protecting devices from electrostatic discharge (ESD countermeasure). In one typical conventional structure, a trench isolation region is formed in a substrate for forming devices having an SOI structure, and an interconnection member to the bulk substrate side is formed in the trench isolation region (for example, see Unexamined Patent Application Publication No. 10-321868). The trench isolation region is ditched fairly deeply by dry-etching, and ions are implanted in the bulk substrate to form well regions that are then filled with a conductive material so as to form the interconnection member.

Wells were thus formed in the bulk substrate of the SOI structure and a plurality of interconnection members to the wells were provided so as to alleviate the self-heating problem, provide protection against electrostatic discharge (ESD countermeasure), and restrain noise transferred via the substrate (cross talk).

In an SOI structure such as that disclosed in Unexamined Patent Application Publication No. 10-321868, the members that interconnect the device substrate with the wells formed in the bulk substrate suffer from the following types of problems.

Wells are formed in the bulk substrate by implanting ions from a deep etched opening or with high energy. This ion implantation made it impossible to accurately establish the characteristics of diodes at the border between the wells and the bulk substrate. In other words, it was difficult to obtain the diode characteristics or ohmic contact required for securing a more stable substrate electric potential.

The present invention, which takes the aforementioned situation into account, is intended to provide a semiconductor substrate having an SOI structure that can ensure a more stable substrate potential, and a manufacturing method and semiconductor device thereof.

### SUMMARY

A semiconductor substrate of the present invention comprises an SOI structure including a single-crystal silicon layer for forming a device formed on an insulating layer; a support substrate of a first conductive-type provided beneath the insulating layer; and a well pattern of a first conductive type or a second conductive type that is provided in a predetermined region of the support substrate.

According to the semiconductor substrate of the present invention, the well pattern is provided in desired locations on the support substrate. The well pattern can be used for stabilizing a predetermined electric potential in the SOI structure for forming a device. The well pattern can also be used as a wiring layer, as a component of a resistive element, and so forth.

In the semiconductor substrate according to the present invention, a predetermined electric potential is applied to the well pattern via a connection member that passes through the insulating layer.

Moreover, in a semiconductor substrate according to the present invention, the predetermined region where the well pattern is provided includes at least another region where a pad is disposed from above. This structure contributes to the use of electrostatic protection.

A semiconductor substrate according to the present invention comprises an SOI structure including a single-crystal silicon layer for forming a device formed on an insulating layer; a support substrate provided beneath the insulating layer; and a conductive layer pattern provided in a predetermined region of the support substrate.

In a semiconductor substrate according to the present invention, a conductive layer pattern is provided in a necessary location on the support substrate. The conductive layer pattern can be used for stabilizing a predetermined electric potential in the SOI structure for forming a device. It can also be used as a wiring layer, as a component of a resistive element, and so forth.

In a semiconductor substrate of the present invention, a predetermined electric potential is applied to the conductive layer pattern via a connection member that passes through the insulating layer.

Moreover, in a semiconductor substrate according to the present invention, the predetermined region where the conductive layer pattern is provided includes at least another region where a pad is disposed from above. This structure contributes to the use of electrostatic protection.

In addition, the aforementioned semiconductor substrate according to the present invention further comprises a well pattern connected with the conductive layer pattern, in the predetermined region of the support substrate.

A method of manufacturing a semiconductor substrate according to the present invention comprises the steps of preparing a seed substrate, and epitaxially growing a single-crystal silicon layer for forming a device on the seed substrate; heat-treating the single-crystal silicon layer to form an insulating layer on the single-crystal silicon layer; preparing a support substrate of a first conductive type, and forming at least a well pattern of a first conductive type or a second conductive type in a predetermined region; bonding the support substrate including the well pattern with the insulating layer formed on the single-crystal silicon layer; and splitting the seed substrate from the insulating layer such that the single-crystal silicon layer is a main surface of the device.

The above method of manufacturing a semiconductor substrate according to the present invention further comprises a step of bonding the support substrate, which is provided with the well pattern in a desired location, to the insulating layer of the seed substrate. The well pattern can be used for stabilizing a predetermined electric potential in the SOI structure for forming a device. The well pattern can also be used as a wiring layer, as a component of a resistive element, and so forth.

A method of manufacturing a semiconductor substrate according to the present invention comprises the steps of preparing a seed substrate, and epitaxially growing a single-crystal silicon layer for forming a device on the seed substrate; heat treating the single-crystal silicon to form an insulating layer on the single-crystal silicon layer; preparing a support substrate; forming at least a conductive layer pattern in a predetermined region of the support substrate; embedding an insulating layer, and then planarizing the surface of the insulating layer; bonding the support substrate including the conductive layer pattern with the insulating layer on the single crystal silicon; and splitting the seed substrate from the insulating layer such that the single-crystal silicon layer is a main surface of the device.

A method of manufacturing the aforementioned semiconductor substrate according to the present invention further comprises a step of bonding the support substrate, which has the conductive pattern in the desired location, to the insulating layer of the seed substrate. The conductive pattern can be used for stabilizing a predetermined electric potential in the SOI structure for forming a device. The conductive pattern can also be used as a wiring layer, as a component of a resistive element, and so forth.

In addition, the aforementioned semiconductor substrate of the present invention further comprises a step of forming beforehand a well pattern that connects to the conductive layer pattern.

A semiconductor device of the present invention comprises a support substrate of a predetermined conductive type that is provided with a well pattern formed in a predetermined region; an insulating layer on the support substrate; a single-crystal silicon layer on the insulating layer; an element isolation region selectively formed in the single-crystal silicon layer; an integrated circuit element arranged in the single-crystal silicon layer; and an electrical connection member that passes from the main surface of the integrated circuit element and down to the well pattern through the insulating layer.

In the semiconductor device of the aforementioned present invention, the well pattern controls an electric potential relating to the integrated circuit element.

Or, the well pattern is used as a wiring layer or as a component of a passive element.

A semiconductor device of the present invention comprises a support substrate that is provided with a conductive layer pattern in a predetermined region; an insulating layer on the support substrate; a single-crystal silicon layer on the insulating layer; an element isolation region selectively formed in the single-crystal silicon layer; an integrated circuit element arranged in the single-crystal silicon layer; and an electrical connection member that passes from the main surface of the integrated circuit element and down to the conductive layer pattern through the insulating layer.

In the aforementioned semiconductor device of the present invention, the conductive layer pattern controls an electric potential relating to the integrated circuit elements.

Or, the conductive layer pattern is used as a wiring layer or as a component of a passive element.

The aforementioned semiconductor device according to the present invention further comprises a well pattern connected with the conductive layer pattern, in a predetermined region of the support substrate.

### BRIEF DESCRIPTION OF THE DRAWINGS

FIG. 1 shows the structure of the major parts of a semiconductor substrate having an SOI structure according to the first embodiment of the present invention.

FIG. 2 is a first cross-sectional view showing a connection member that is used in the structure of FIG. 1.

FIGS. 3(a) and 3(b) are second cross-sectional views showing a connection member that is used in the structure of FIG. 1.

FIGS. 4(a)-4(d) are cross-sectional views showing the manufacturing process of the semiconductor substrate having the SOI structure according to the second embodiment of the present invention.

FIG. 5 is cross-section view showing the structure of the semiconductor device according to the third embodiment of the present invention.

FIG. 6 shows the structure of the major parts of the semiconductor substrate having the SOI structure according to the fourth embodiment of the present invention.

FIG. 7 is a first cross-sectional view showing a connection member that is used in the structure of FIG. 6.

FIG. 8 is a second cross-sectional view showing a connection member that is used in the structure of FIG. 6.

FIGS. 9(a)-9(d) are cross-sectional views showing the manufacturing process of the semiconductor substrate having the SOI structure according to the fifth embodiment of the present invention.

### DETAILED DESCRIPTION

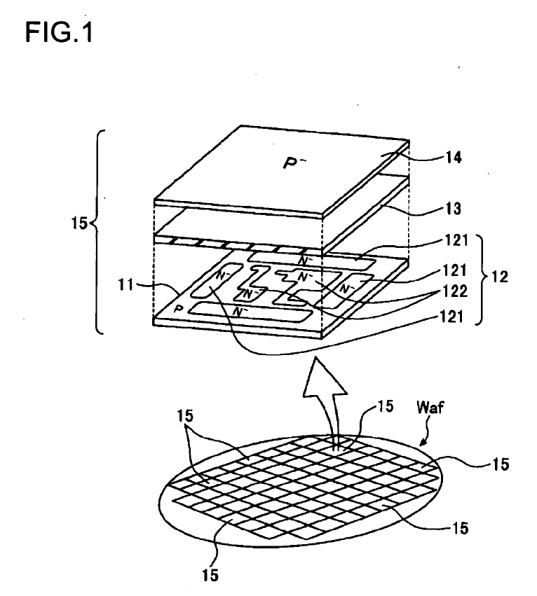

FIG. 1 shows the structure of the major parts of a semiconductor substrate having an SOI structure according to the first embodiment of the present invention. The figure shows a one-chip region on a wafer (Waf). A P⁻ type single-crystal silicon layer 14 having a low-density P⁻ type impurity, for example, is formed on an insulating layer 13. The single-crystal silicon layer 14 is for forming a device. In addition, under the insulating layer 13 a P⁻ type support substrate 11, for example, is formed. This support substrate 11 is provided in advance with a plurality of N-type well patterns 12 having a low-density N-type impurity. These are deposited as multi layers to comprise a semiconductor substrate 15 having an SOI structure.

A predetermined electric potential is applied to each of the well patterns 12 via a connection member, described later, that passes through the insulating layer 13. The predetermined region for providing the well patterns 12 includes at least another region where a pad is provided from above. Here, since a pad is provided in the peripheral region of the chip, a region 121 within the well patterns 12 corresponding to a pad is provided. Other regions 122 are also provided in accordance with element regions that will be provided. These regions can be used for stabilizing a predetermined electric potential in the SOI structure for forming a device.

According to the aforementioned construction, the well patterns 12 (121, 122) are provided in the desired locations on the support substrate 11. These well patterns 12 can be used in order to stabilize a predetermined electric potential in the SOI structure for forming a device.

They can also be used as a wiring layer, as a component of a resistive element, and so forth.

Moreover, the well patterns 12 are not limited to the aforementioned embodiment but can be patterned as desired in accordance to element regions to be provided and to their accompanying wiring circuits. There may be sites where the well patterns having the same conductive type as the support substrate 11 are formed. This type of well pattern can be used as an ESD countermeasure. Generally in the case of an ESD countermeasure, a well pattern is used on the P-channel element side, and ohmic contact is used on the N-channel element side.

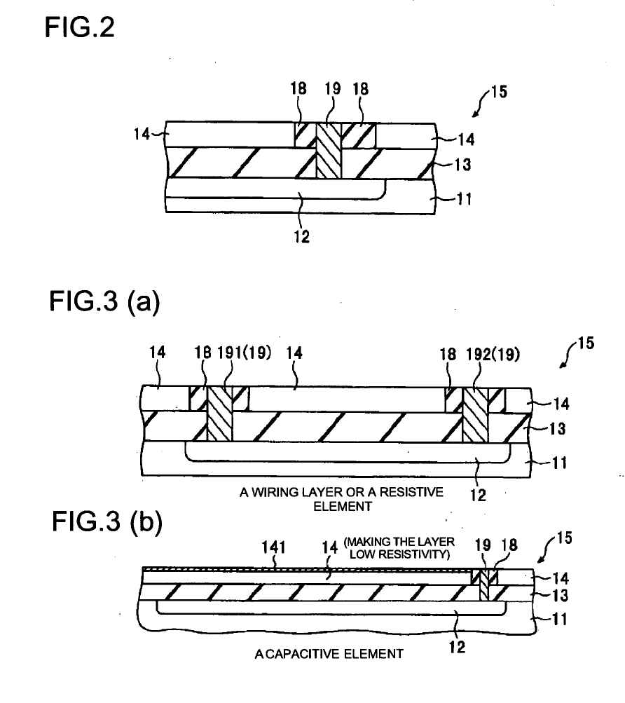

FIG. 2 is a first cross-sectional view showing the connection member that is used in the structure of FIG. 1. A trench isolation region 18 is formed in the semiconductor substrate 15, which has an SOI structure. The connection member 19 is provided such that it reaches from the top of the trench isolation region 18 down to the well pattern 12, passing through the insulating layer 13 along the way. The connection member 19 is, for example, a W (tungsten) plug with a barrier metal. Here, the connection member 19 is formed, for example, by forming a penetration hole after the trench isolation region 18 is formed but before a gate layer of the device is formed, then subsequently filling the penetration hole with the W plug and planarizing it. The method of forming the connection member 19 is not limited to the above method. The connection member 19 may also be formed at the time when a first metal layer is formed or when the plug is formed, after a polysilicon plug or a device gate layer are formed.

By providing the connection member 19 in desired locations, a predetermined electric voltage (a ground potential, for example) is applied to the well patterns 12 through the wiring layer from the pad provided in the upper layer, which is not indicated in the drawing. In this way, the well patterns 12 (121, 122) serve, for example, as a desirable diode circuit for protecting the predetermined pad from electrostatic discharge and contribute to the stabilization of the body potential of the SOI MOSFET. The patterns also contribute to an alleviation of the self-heating problem (a well is not necessarily required). Also it is possible to realize a capacitor by utilizing the insulating layer 13. This structure contributes greatly to the reduction of cross talk, particularly in high-frequency products.

FIG. 3(a) is a second cross-sectional view showing the connection member that is used in the structure of FIG. 1. One connection member 191, which is the same as the connection member 19 in FIG. 2, is located a predetermined distance apart from another connection member 192 in FIG. 3(a). The well patterns 12 function as a wiring layer and as a resistor element. In other words, the well patterns 12 become paths for transmitting a predetermined signal through the wiring layer that is provided on the upper layer, which is not shown. In this way, these patterns contribute to a higher density of circuit integration and also contribute to an alleviation of the self-heating problem.

FIG. 3(b) is a second cross-sectional view showing the connection member that is used in the structure of FIG. 1. A capacitive element is formed using the well pattern 12 shown in FIG. 2 as a lower electrode, the insulating layer 13 as a capacitive dielectric layer, and a silicide layer 141 as an upper electrode. The silicide layer 141 is formed by introducing an impurity to the single-crystal silicon layer 14, thereby lowering resistivity and converting the upper portion of the single-crystal silicon layer 14 into a silicide. The connection member 19 serves as an outgoing line for the lower electrode. In actuality, the insulating layer 13 is a thin thermal oxide layer that is planarized with high precision so as to serve as a stable capacitive element. Also, the above structure can be manufactured in a process that is shorter than a process for forming a multilayer wiring layer. In this way, this structure contributes to a higher density of circuit integration.

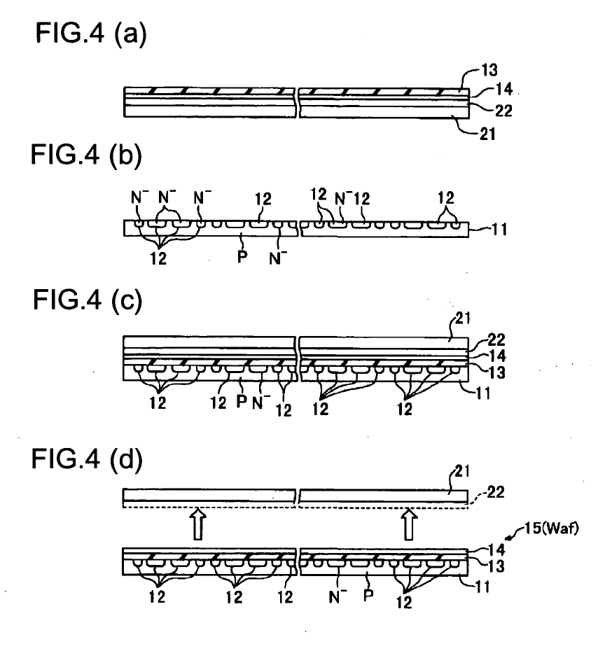

A second embodiment of the present invention is shown in FIGS. 4(a) to 4(d). FIGS. 4(a) to 4(d) show cross-sectional views of a sequence of steps of a method for manufacturing a semiconductor substrate having an SOI structure. The method is related to manufacturing the wafer (Waf) for the semiconductor substrate 15 of the structure shown in FIG. 1. In places where the structure is identical to those shown in FIG. 1, the same reference numerals are used. Here, a known fabrication process, ELTRAN, is used.

As shown in FIG. 4(a), a seed substrate 21 that serves as the base upon which the SOI structure is formed is prepared and a porous silicon layer 22 is formed thereupon. A low-density P-type single-crystal silicon layer 14 for forming a device layer is epitaxially grown on the porous silicon layer 22. After that, thermal oxidation is performed to form an insulating layer (oxide film) 13 (using the ELTRAN manufacturing process).

On the other hand, as shown in FIG. 4(b), a P-type support substrate (silicon substrate) 11 is prepared. The support substrate is patterned with an ion implantation mask according to the embodiment of the present invention and then ions are implanted so as to introduce a low-density N-type impurity to the support substrate 11, and form N-type well patterns 12 (121, 122) in predetermined regions. The N-type well patterns 12 are in accordance with the circuit formed on the SOI substrate. If the final thickness of the support substrate 11 is about 725 μm, the N-type well patterns 12 are formed by, for example, implanting phosphorous atoms at an acceleration voltage of about 300 keV and a dose of about 1×10¹⁴ cm⁻³. In addition, contacts may be formed, for example, by implanting arsenic atoms at an acceleration voltage of about 70 keV and a dose of about 2×10¹⁵ cm⁻³.

As shown in FIG. 4(c), the support substrate 11 provided with the well patterns 12 are bonded with the insulating layer 13 of the seed substrate 21. This bonding is implemented by heat treatment.

Next, as shown in FIG. 4(d), the seed substrate 21 is split off. This splitting is implemented by spraying a water jet on the edge of the porous silicon layer 22 according to the ELTRAN manufacturing process. After that, the porous silicon layer 22 that is left on the single-crystal silicon layer 14 is selectively removed, and the single-crystal silicon layer 14 surface is planarized by a hydrogen annealing step.

According to the method of the above embodiment, the well patterns 12 have already been formed in the desired locations on the support substrate 11 before the support substrate 11 is bonded to the insulating layer 13 of the seed substrate 21. These well patterns 12 can be used in order to stabilize a predetermined electric potential in the SOI structure for forming a device. They can also be used as a wiring layer, as a component of a resistive element, and so forth.

A manufacturing process called “Smart Cut” also exists. In the case of Smart Cut, the porous silicon 22 in FIG. 4(a) is not needed. After the substrates are bonded, as in FIG. 4(c), hydrogen is introduced at a predetermined energy and concentration from the substrate 21 on which the insulating layer 13 has been formed. The silicon bonds hence break in a region at a predetermined depth, leading to a fragile state. The substrates are separated by subsequent heat treating, yielding the same arrangement as that shown in FIG. 4(d). There is also a method that achieves perfect polishing without going through this type of separation process.

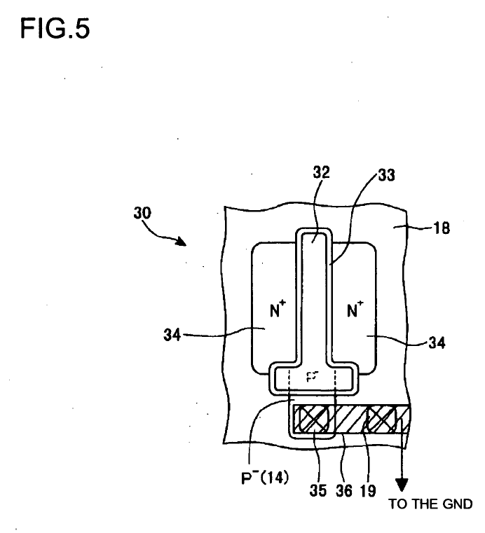

A third embodiment of the present invention is shown in FIG. 5, which shows a plan view of the structure of a semiconductor device. The figure shows one example of an SOI MOSFET formed in a semiconductor substrate having the SOI structure of FIG. 1 and the connection member structure shown in FIG. 2 to supply voltage. In places where the structure is identical to those shown in FIG. 1 and FIG. 2, the same reference numerals are used in descriptions.

The SOI MOSFET 30 comprises a P⁻ type single-crystal silicon layer 14 as the body and a gate electrode 32 via a gate oxide layer (not shown in the figure) above a channel region 31. The gate electrode 32 has a so-called T-gate structure and a body region 14 that is surrounded by a trench isolation region 18. At the side portion of the gate electrode 32, a side wall (spacer) 33 is formed after the formation of an N⁻ extension region (not shown in the figure) that has a lower density than a source/drain region. An N⁺ region 34 of the source/drain region not shown in the figure is contacted with a predetermined contact wire.

Here, a predetermined contact 35 is also contacted with the P⁻ type single-crystal silicon layer 14 of the body and, normally, is connected to ground potential. Since the ground potential is applied to the well patterns 12 via the connection member, which is not shown, the contact 35 connects to the connection member 19 via the wiring layer 36. The electric potential of the body of the SOI MOSFET 30 is thereby made more stable. This structure contributes to an alleviation of the self-heating problem.

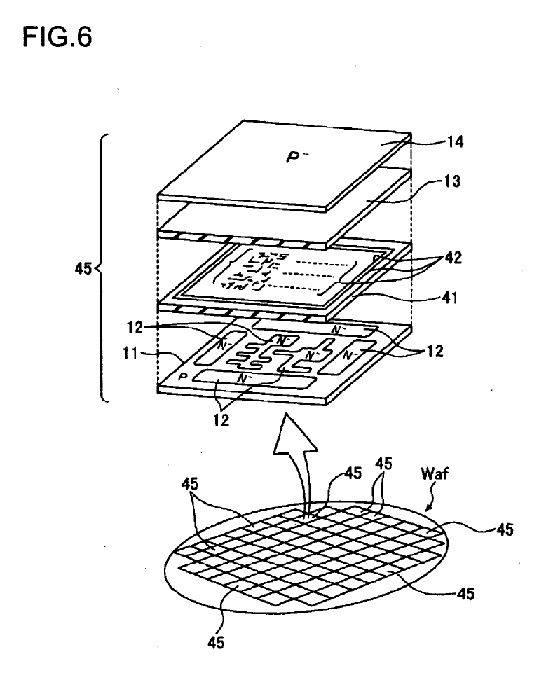

A fourth embodiment of the present invention is shown in FIG. 6. FIG. 6 shows the structure of the major parts of the semiconductor substrate having an SOI structure. In places that are the same as those in the first embodiment, the same reference numerals are used in descriptions.

The figure shows a one-chip region on a wafer (Waf). A P⁻ type single-crystal silicon layer 14 is provided on the insulating layer 13. In addition, under the insulating layer 13, a P-type support substrate 11 is provided, for example. This support substrate 11 is provided in advance with the N-type well patterns 12 with a low-density N-type impurity. Furthermore, an interlayer dielectric layer 41 is disposed on the surface of the support substrate 11, including above the well patterns 12, and a conductive layer pattern 42 is provided beforehand in the interlayer dielectric layer 41. The conductive layer pattern 42 may be, for example, a doped polysilicon or a metal wiring. These are deposited as multi-layers so as to comprise a semiconductor substrate 45 having an SOI structure.

The well patterns 12 and the conductive layer patterns 42 can be disposed beforehand in the desired locations and, for example, a predetermined electric potential (also including a signal) is applied to them via a connection member that passes through the insulating layer 13, as described later. This enables the patterns to be used for stabilizing a predetermined electric potential in the SOI structure for forming a device. They can also be used as a wiring layer, as a component of a resistive element, and so forth.

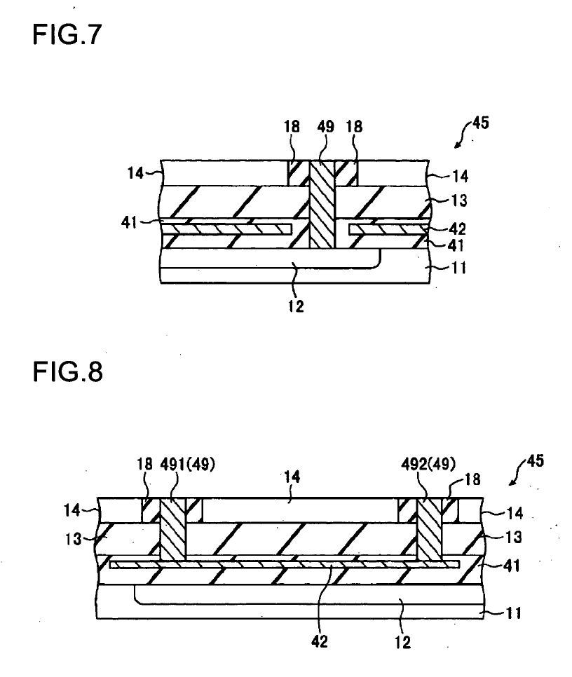

FIG. 7 is a first cross-sectional view showing the connection member used in the structure of FIG. 6. A trench isolation region 18 is formed in a semiconductor substrate 45 having an SOI structure. The connection member 49 is provided such that it reaches from the top of the trench isolation region 18 down to the well pattern 12, passing through the insulating layer 13 and the interlayer dielectric layer 41 on the way. The connection member 49 is, for example, a W (tungsten) plug with a barrier metal. Here, the connection member 49 is provided by, for example, forming the trench isolation region 18 and then, prior to forming the gate layer of the device, forming a penetration hole in a region without the conductive layer pattern 42, then subsequently filling the penetration hole with the W plug and planarizing it. The method of forming the connection member 49 is not limited to this method. The connection member 49 may also be formed at the time when a first metal layer is formed or when the plugs are formed, after a polysilicon plug or a device gate layer is formed.

By providing the connection member 49 in the desired locations, the predetermined electric voltage (a ground potential, for example) is applied to the well patterns 12 through the wiring layer from the pad provided in the upper layer, which is not indicated in the drawing. As in the first embodiment, this structure contributes to the stabilization of the electrostatic protection diode circuit with respect to the pad and to the stabilization of the body potential of the MOSFET. The structure also contributes to an alleviation of the self-heating problem (a well is not necessarily required). This type of structure contributes greatly to the reduction of cross talk, particularly in high-frequency products.

FIG. 8 is a second cross-sectional view showing the connection member that is used in the structure shown in FIG. 6. A connection member 491, which is the same as the connection members 49, is located a predetermined distance apart from another connection member 492 so that they connect with the conductive layer pattern 42. The conductive layer pattern 42 functions as a wiring layer or as a component of a resistive element. In other words, the conductive layer pattern 42 is a path for transmitting a predetermined signal through the wiring layer that is provided on the upper layer, which is not shown. This structure contributes to an alleviation of the self-heating problem. Also it is possible to form a capacitor by utilizing the insulating layer 13 or the interlayer dielectric layer 41.

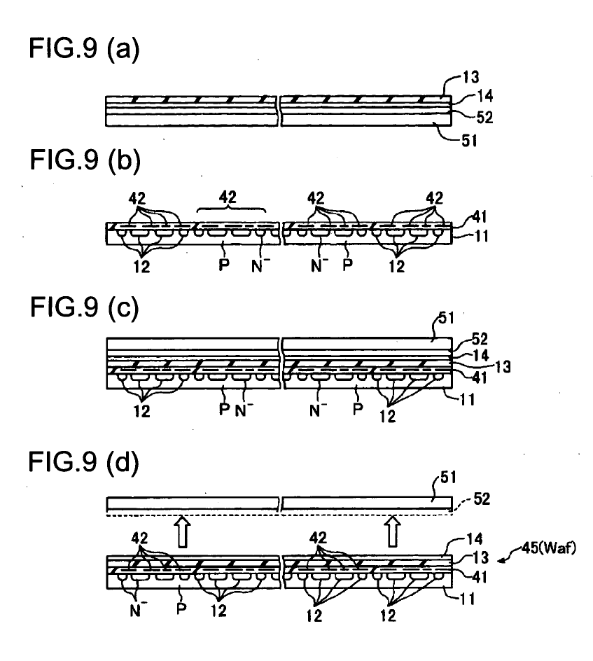

A fifth embodiment of the present invention is shown in FIGS. 9(a) to 9(d). FIGS. 9(a) to 9(d) are cross-sectional views showing a sequence of steps of a method for manufacturing a semiconductor substrate according to the fifth embodiment of the present invention. The method is related to manufacturing the wafer (Waf) for the semiconductor substrate 45 whose structure is shown in FIG. 6. Components that are the same as those in FIG. 7 are referred to using the same reference numbers as those in FIG. 7. Here, too, a known manufacturing process, ELTRAN, is used.

As shown in FIG. 9(a), a seed substrate 51 as the base for forming an SOI structure is prepared, and a porous silicon layer 52 is formed. The low-density P-type single-crystal silicon layer 14 for forming a device is epitaxially grown on the seed substrate 51. After that, thermal oxidation is performed to form an insulating layer 13 (by the ELTRAN manufacturing process).

On the other hand, as shown in FIG. 9(b), the P-type support substrate (silicon substrate) 11 is prepared. The support substrate is patterned with an ion implantation mask according to an embodiment of the present invention and then ions are implantated so as to introduce a low-density N-type dopant into the support substrate 11 and form the N-type well patterns 12 in predetermined regions. The N-type well patterns 12 are in accordance with the circuit to be constructed on the SOI substrate. If the final thickness of the support substrate 11 is about 725 μm, the N-type well patterns 12 are formed by, for example, implanting phosphorous atoms at an acceleration voltage of about 300 keV and a dose of about 1×10¹⁴ cm⁻³. In addition, contacts may be formed, for example, by implanting arsenic atoms at an acceleration voltage of about 70 keV and a dose of about 2×10¹⁵ cm⁻³. In addition, the interlayer dielectric layer 41 is formed on the main surface containing the well patterns 12, and a doped polysilicon layer, for example, is patterned with a predetermined pattern on the interlayer dielectric layer 41 so as to form a conductive layer pattern 42. Then, the interlayer dielectric layer 41 is again deposited and planarized. Planarization is achieved by an etching process or by a CMP (chemical-mechanical polishing) process.

As shown in FIG. 9(c), the support substrate 11 provided with the conductive layer pattern 42 is bonded with the insulating layer 13 of the seed substrate 51. The bonding is implemented during heat treatment.

As shown in FIG. 9(d), the seed substrate 51 is split off. This splitting is implemented by spraying a water jet on the edge of the porous silicon layer 52 according to the ELTRAN manufacturing process. After that, the porous silicon layer 52 that is left on the single-crystal silicon layer 14 is selectively removed, and the single-crystal silicon layer 14 surface is planarized by a hydrogen annealing step. Moreover, as described above, apart from this ELTRAN manufacturing process, the Smart Cut or complete polishing manufacturing process may be used.

According to the method of the above embodiment, the well patterns 12 and conductive layer patterns 42 are formed in the desired locations on the support substrate 11 before the support substrate 11 is bonded to the insulating layer 13 of the seed substrate 21. These well patterns 12 and conductive layer patterns 42 can be used in order to stabilize a predetermined electric potential in the SOI structure for forming a device. They can also be used as a wiring layer, as a component of a resistive element, and so forth.

For example, when forming an integrated circuit that includes CMOS in an SOI structure, a ground potential is applied to the well patterns 12 and is used as a body potential, and this pattern is used as an electrostatic protection circuit for a pad. This structure is also useful in alleviating the self-heating problem.

SOI MOSFETs, moreover, are not limited to the structure of FIG. 5. The conductive layer pattern 42 can be used in a variety of structures, including but not limited to those where a power supply potential is applied, or those used in signal communications among devices, or those used in resistive elements, inductors, capacitors and so forth. Hence, it is possible to achieve a highly reliable semiconductor device in which the electric potential directly below a transistor is easily controlled to the desired level and that contributes to the reduction of cross talk. Moreover, apart from the aforementioned embodiments, an embodiment wherein the conductive layer pattern (42) is structured in multiple layers is also conceivable.

According to the present invention as described herein, on the support substrate below the insulating layer in SOI, well patterns and/or conductive patterns are provided in desired locations. These patterns beneath the insulating layer can be used for stabilizing the predetermined electric potential in the SOI structure for forming a device. They can also be used as a wiring layer, as a component of a resistive element, and so forth. This structure is also useful in alleviating self-heating. As a result, a more stable substrate potential can be obtained, providing a semiconductor substrate having an SOI structure of high reliability that contributes to higher levels of integration, and a manufacturing method and a semiconductor device thereof.

The entire disclosure of Japanese Patent Application No. 2002-345827 filed Nov. 28, 2002 is incorporated by reference.

What is claimed is:

1. A semiconductor substrate comprising:
an SOI structure including a single-crystal silicon layer for forming a device formed on an insulating layer;
a support substrate of a first conductive-type that is provided beneath the insulating layer; and
a well pattern of one of a first conductive type and a second conductive type that is provided in a predetermined region of the support substrate.

2. A semiconductor substrate according to claim 1, wherein a predetermined electric potential is applied to the well pattern via a connection member that passes through the insulating layer.

3. A semiconductor substrate according to claim 1, wherein the predetermined region where the well pattern is provided includes at least another region where a pad is disposed.

4. A semiconductor substrate comprising:
an SOI structure including a single-crystal silicon layer for forming a device formed on an insulating layer;
a support substrate provided beneath the insulating layer; and
a conductive layer pattern provided in a predetermined region of the support substrate.

5. A semiconductor substrate according to claim 4, wherein a predetermined electric potential is applied to the conductive layer pattern via a connection member that passes through the insulating layer.

6. A semiconductor substrate according to claim 4, wherein the predetermined region where the conductive layer pattern is provided includes at least another region where a pad is disposed.

7. A semiconductor substrate according to claim 4, further comprising a well pattern connected with the conductive layer pattern, in the predetermined region of the support substrate.

8. A method of manufacturing a semiconductor substrate comprising the steps of:
preparing a seed substrate, and epitaxially growing a single-crystal silicon layer for forming a device on the seed substrate;
heat-treating the single-crystal silicon layer to form an insulating layer on the single-crystal silicon layer;
preparing a support substrate of a first conductive type and forming at least a well pattern of one of a first conductive type and a second conductive type in a predetermined region;
bonding the support substrate including the well pattern with the insulating layer formed on the single-crystal silicon layer; and
splitting the seed substrate from the insulating layer such that the single-crystal silicon layer is a main surface of the device.

9. A method of manufacturing a semiconductor substrate comprising the steps of:
preparing a seed substrate, and epitaxially growing a single-crystal silicon layer for forming a device on the seed substrate;
heat-treating the single-crystal silicon to form an insulating layer on the single-crystal silicon layer;
preparing a support substrate;
forming at least a conductive layer pattern in a predetermined region of the support substrate, embedding an insulating layer, and then planarizing the surface of the insulating layer;
bonding the support substrate including the conductive layer pattern with the insulating layer on the single crystal silicon; and
splitting the seed substrate from the insulating layer such that the single-crystal silicon layer is the main surface of the device.

10. A method of manufacturing a semiconductor substrate according to claim 9, further comprising a step of forming a well pattern that connects to the conductive layer pattern on the support substrate.

11. A semiconductor device comprising:
a support substrate of a predetermined conductive type that is provided with a well pattern formed in a predetermined region;
an insulating layer on the support substrate;
a single-crystal silicon layer on the insulating layer;
an element isolation region selectively formed in the single-crystal silicon layer;
an integrated circuit element arranged in the single-crystal silicon layer; and
an electrical connection member that passes from the main surface of the integrated circuit element and to the well pattern through the insulating layer.

12. The semiconductor device of claim 11, wherein the well pattern controls the electric potential relating to the integrated circuit element.

13. The semiconductor device of claim 11, wherein the well pattern is used as at least one of a wiring layer and a component in a passive element.

14. A semiconductor device comprising:
a support substrate including a conductive layer pattern formed in a predetermined region;
an insulating layer on the support substrate;
a single-crystal silicon layer on the insulating layer;
an element isolation region selectively formed in the single-crystal silicon layer;
an integrated circuit element arranged upon the single-crystal silicon layer; and
an electrical connection member that passes from the main surface of the integrated circuit element and to the conductive layer pattern through the insulating layer.

15. The semiconductor device of claim 14, wherein the conductive layer pattern controls the electric potential relating to the integrated circuit element.

16. The semiconductor device of claim 14, wherein the conductive layer pattern is used as at least one of a wiring layer and a component in a passive element.

17. A semiconductor device according to claim 14, further comprising a well pattern connected with the conductive layer pattern, in the predetermined region of the support substrate.
